(19) United States
(12) Patent Application Publication
(10) Pub. No.: US 2009/0288678 A1
(43) Pub. Date: Nov. 26, 2009

(54) METHOD FOR MANUFACTURING DISK

(75) Inventors: Hiroshi Akiba, Higashine (JP); Atsushi Furuyama, Higashine (JP); Yukimasa Hinata, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/362,295

(22) Filed: Jan. 29, 2009

(30) Foreign Application Priority Data
May 21, 2008 (JP) 2008-133221

(51) Int. Cl. B08B 3/12; B08B 7/00

(52) U.S. Cl. 134/1; 134/33; 134/6

(57) ABSTRACT

A disk manufacturing method that includes: processing a surface of a disk while rotating the disk; cleaning the surface of the disk after the processing to remove a processing residue from the disk; drying the disk after the cleaning; and end-face cleaning that cleans an end-face of the disk while rotating the disk, the end-face cleaning being performed concurrently with at least one of the processing and the cleaning.

### CROSS-REFERENCE TO RELATED APPLICATION

This application is based upon and claims the benefit of priority of the prior Japanese Patent Application No. 2008-133221, filed on May 21, 2008, the entire contents of which are incorporated herein by reference.

### FIELD

The embodiments discussed herein are related to a disk manufacturing method capable of polishing a surface of the disk.

### BACKGROUND

Recently with the progress of information society, developments of an information recording system or an information storage device having dramatically high recording density are demanded. A magnetic disk drive in which an access is made to information using a magnetic field is an information storage device in which the information can be rewritten. Among others, a floating head type magnetic disk drive in which a head used to apply the magnetic field is floated by an air flow generated by rotation of the disk is widely used as the compact information storage device having the high recording density.

In the floating head type magnetic disk drive, when the head contacts the disk in rotation, the information recorded in the disk may be possibly broken. On the other hand, in order to efficiently apply the magnetic field to the disk to enhance access accuracy, preferably the head is brought close to the disk. And recently a head floating amount is decreased to an order of several nanometers. Therefore, the need to enhance evenness of the surface of the disk arises while satisfying the need to accurately float the head by a defined amount arises.

FIG. 1 illustrates a conventional method for manufacturing a magnetic disk.

When a magnetic disk is manufactured, first of all, a polishing material 11B (for example, non-woven cloth) wound around a rubber roller 11A is pressed against a nonmagnetic substrate 10, and the nonmagnetic substrate 10 is rotated to polish a surface of the nonmagnetic substrate 10 (step S11 of FIG. 1). An in-plane recording system in which a recording medium is magnetized along a surface of the recording medium or a perpendicular recording system in which the recording medium is magnetized in a direction perpendicular to the surface of the recording medium is widely used as the information recording system in which the information is recorded in the magnetic disk. In the in-plane recording system, a groove is circumferentially formed on the surface of the nonmagnetic substrate 10 (texture processing). In the perpendicular recording system, the surface of the nonmagnetic substrate 10 is mirror-polished (polishing processing).

When the surface of the nonmagnetic substrate 10 is polished, the nonmagnetic substrate 10 is cleaned to remove shavings generated by the polishing process. In the example illustrated in FIG. 1, the surface of the nonmagnetic substrate 10 is sprayed with water containing a cleaning material from a spray machine 12, thereby a residue adhering to the nonmagnetic substrate 10 is roughly washed out (step S21 of FIG. 1). Then a tape 13B wound around a rubber roller 13A is pressed against the nonmagnetic substrate 10 and the nonmagnetic substrate 10 is rotated. Since the surface of the nonmagnetic substrate 10 is sprayed with water having an ultrasonic oscillation from a spray machine 14, the cleaning material and the shavings fitted in the groove are wiped out (step S22 of FIG. 1). When the residue adhering to the surface of the nonmagnetic substrate 10 is removed, the nonmagnetic substrate 10 is dipped in a water tank 18 filled with water containing a cleaning material to perform ultrasonic cleaning (step S23 of FIG. 1). The residue floated onto the surface of the nonmagnetic substrate 10 by the ultrasonic cleaning is scrubbed by a scrubbing material 16 (such as sponge) (step S24 of FIG. 1), and the nonmagnetic substrate 10 is sprayed with the water having the ultrasonic oscillation from a spray machine 17, thereby the residue scrubbed by the scrubbing material 16 is washed out (step S25 of FIG. 1).

The cleaned nonmagnetic substrate 10 is rotated at high speed and dried (step S31 of FIG. 1).

When the surface processing of the nonmagnetic substrate 10 is finished, a recording layer is laminated on the nonmagnetic substrate 10 to produce a magnetic disk.

At this point, when the residue generated by the polishing still remains, the recording layer is laminated on the residue adhered to the nonmagnetic substrate, and sometimes on the surface of the magnetic disk, an unwanted projection is formed or a flaw is generated. When the projection or flaw is generated on the surface of the magnetic disk, the head possibly collides with the projection, or the projection or flaw possibly has an adverse influence on electromagnetic induction of the head to erase data recorded in the magnetic disk. Therefore, there is a strong demand on improving evenness of the surface of the magnetic disk.

For example, Japanese Laid-open Patent Publication No. 2007-197235 discloses a technique, wherein a through-hole of the magnetic disk which becomes an alignment reference during surface processing is polished to form a perfect circle by a foaming resin in addition to a brush. Japanese Laid-open Patent Publication Nos. 04-001924 and 2005-293840 disclose a technique, wherein a chamfered surface is formed in an outer circumferential end-face and a texture is formed along a circumferential direction of the disk in the chamfered surface. In the technique disclosed in Japanese Laid-open Patent Publication No. 2007-197235, a shift of a rotating shaft can be reduced in rotating the nonmagnetic substrate to improve processing accuracy of the surface of the magnetic disk. In the technique disclosed in Japanese Laid-open Patent Publication No. 04-001924, it is possible to prevent a problem in which dust is generated by scrubbing an end-face of a disk and adheres to its surface when the nonmagnetic substrate is taken out from or put in a container.

However, even if the above-described techniques are used, the problem that the projection or flaw is generated on the surface of the magnetic disk cannot be prevented sufficiently. This is attributed to large surface roughness on the end-face of the nonmagnetic substrate after the polishing process.

FIG. 2 illustrates surface roughness of a magnetic disk manufactured according to the manufacturing steps in FIG. 1.

FIG. 2 illustrates surface roughness on the end-face of the outer circumferential side of the magnetic disk and surface roughness on the surface of the magnetic disk. The surface roughness tends to be larger on the end-face than on the surface of the nonmagnetic substrate. Therefore, the residue adhering to the end-face of the nonmagnetic substrate enters into a minute pit, which is hard to be removed completely, and adheres to the surface of the nonmagnetic substrate during the production process, eventually causing a problem that a projection or flaw is generated on the surface of the magnetic disk.

In view of the foregoing, there is provided a disk manufacturing method capable of reducing a problem that the recording layer is laminated on the surface of the disk while the residue adheres to the surface of the disk.

### SUMMARY

According to an aspect of the invention, a method for manufacturing a disk includes:

processing a surface of a disk while rotating the disk;

cleaning the surface of the disk after the processing to remove a processing residue from the disk;

drying the disk after the cleaning; and

end-face cleaning that cleans an end-face of the disk while rotating the disk, the end-face cleaning being performed concurrently with at least one of the processing and the cleaning.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates a conventional process for manufacturing a magnetic disk;

FIG. 2 illustrates surface roughness of the magnetic disk manufactured according to the process in FIG. 1;

FIG. 3 illustrates a method for manufacturing a magnetic disk according to a first embodiment of the present invention;

FIG. 4 illustrates a positional relationship between a tape device and a nonmagnetic substrate;

FIG. 5 partially illustrates a method for manufacturing a magnetic disk according to a second embodiment of the present invention;

FIG. 6 partially illustrates a method for manufacturing a magnetic disk according to a third embodiment of the present invention;

FIG. 7 illustrates a comparison of the number of residues adhering to a nonmagnetic substrate after the polishing process between the conventional example and the first embodiment;

FIG. 8 illustrates a comparison of the number of residues adhering to the nonmagnetic substrate after the polishing process between the conventional example and the second embodiment;

FIG. 9 illustrates a comparison of surface roughness of the nonmagnetic substrate after the polishing process between the conventional example and the first embodiment;

FIG. 10 illustrates a comparison of surface roughness of the nonmagnetic substrate after the polishing process between the conventional example and the second embodiment;

FIG. 11 illustrates a comparison of the number of residues adhering to the nonmagnetic substrate before lamination between the conventional example and the first embodiment;

FIG. 12 illustrates a comparison of the number of residues adhering to the nonmagnetic substrate before the lamination between the conventional example and the second embodiment;

FIG. 13 illustrates a comparison of the number of scratches generated in a magnetic disk surface between the conventional example and the first embodiment;

FIG. 14 illustrates a comparison of the number of scratches generated in the magnetic disk surface between the conventional example and the second embodiment;

FIG. 15 illustrates a comparison of surface roughness of a magnetic disk between the conventional example and the first embodiment; and

FIG. 16 illustrates a comparison of average linear height of the magnetic disk between the conventional example and the second embodiment.

### DESCRIPTION OF EMBODIMENTS

In the following, specific embodiments that correspond to a basic mode described in summary will be explained with reference to the drawings.

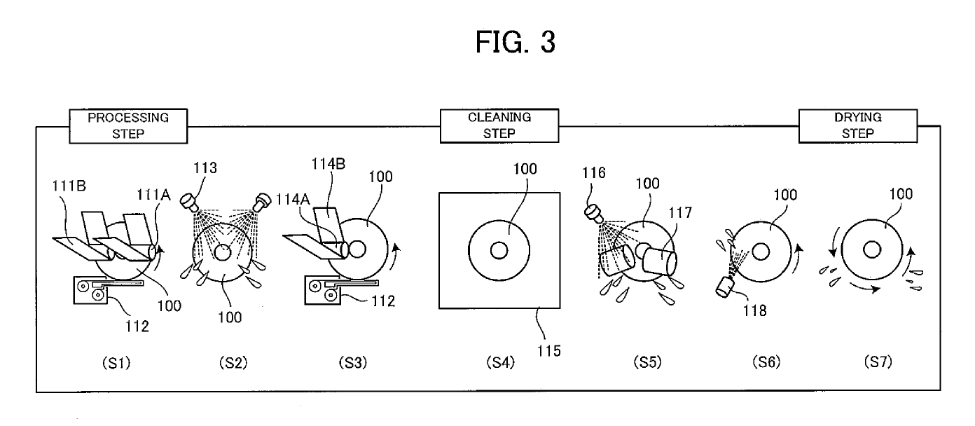

FIG. 3 illustrates a method for manufacturing a magnetic disk as an embodiment of the basic mode of the disk manufacturing method.

The magnetic disk manufacturing method of the present embodiment includes a surface processing step of polishing a surface of a nonmagnetic substrate (step S1 of FIG. 3), a cleaning step of cleaning the nonmagnetic substrate (steps S2, S3, S4, S5, and S6 of FIG. 3), a drying step of drying the nonmagnetic substrate (step S7 of FIG. 3), and a lamination step of laminating a recording layer on the nonmagnetic substrate. FIG. 3 illustrates the steps except the lamination step.

At the surface processing step in step S1 of FIG. 3, a disk-shaped nonmagnetic substrate 100 is attached to a rotary device which rotates the disk, a polishing material 111B wound on a rubber roller 111A is pressed against the nonmagnetic substrate 100, and a tape device 112 is disposed at an end-face of an outer circumferential side of the nonmagnetic substrate 100. Non-woven cloth and urethane foam or the like can be used as the polishing material 111B. The nonmagnetic substrate 100 corresponds to an example of the disk in the basic mode of the disk manufacturing method.

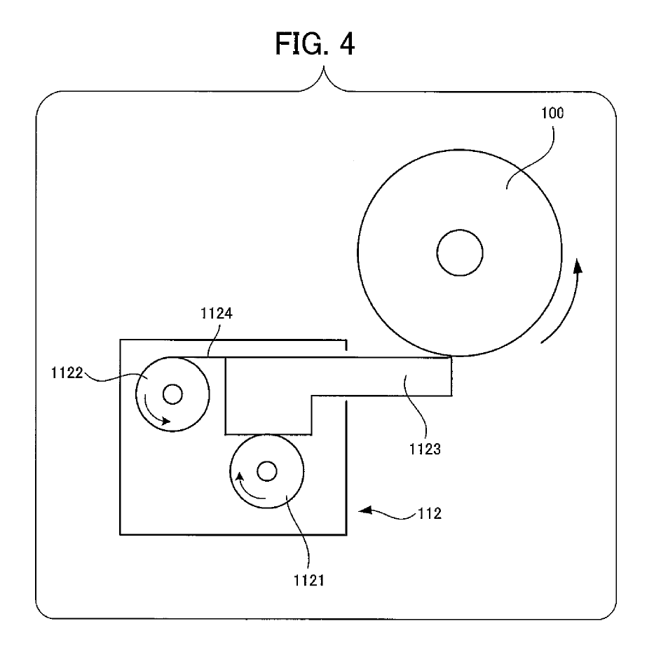

FIG. 4 illustrates a positional relationship between the tape device 112 and the nonmagnetic substrate 100.

The tape device 112 includes a rail section 1123 which is extended toward the nonmagnetic substrate 100, a tape 1124 which is supported by the rail section 1123, an unused roller 1121 around which an unused tape 1124 is wound, and a used roller 1122 around which the used tape 1124 is wound. A leading end of the rail section 1123 is pressed against an end-face of the outer circumferential side of the nonmagnetic substrate 100.

When the rotary device rotates the nonmagnetic substrate 100, the polishing material 111B of FIG. 3 polishes the surface of the nonmagnetic substrate 100. At this point, because a portion of the tape 1124 corresponding to the leading end of the rail section 1123 contacts the end-face of the outer circumferential side of the nonmagnetic substrate 100, the tape 1124 wipes out shavings generated by the polishing. In the first embodiment, as illustrated in FIG. 4, the unused roller 1121 and the used roller 1122 are rotated in the opposite directions, the unused roller 1121 supplies an unused portion of the tape 1124 to the rail section 1123 when the residue is removed by rotating the nonmagnetic substrate 100, and the used roller 1122 winds the used portion. Thus, because a new portion of the tape 1124 always contacts the end-face of the nonmagnetic substrate 100, the residue can be accurately removed. The process of step S1 in which the surface of the nonmagnetic substrate 100 is polished and the end-face of the outer circumferential side of the nonmagnetic substrate 100 is cleaned corresponds to an example of the polishing step and the end-face cleaning step as well in the basic mode of the disk manufacturing method.

Here, it is preferable to employ an application mode of the disk manufacturing method in which the end-face cleaning step wipes out the residue from the end-face of the disk by bringing a tape into contact with the end-face of the disk.

Since the tape is brought into contact with the end-face of the disk while the disk is rotated, the residue adhered to the end-face of the disk can be easily wiped out.

It is also preferable to employ an application mode of the disk manufacturing method in which the processing step further includes a polishing step that polishes the surface of the disk by bringing a polishing material into contact with the surface of the disk while rotating the disk, and the end-face cleaning step is performed concurrently with the polishing step.

Since in many cases, the polishing step is performed while rotating the disk, thereby it is possible to clean the end-face of the disk surely without increasing a processing time by performing the end-face cleaning step and the polishing step together.

After polishing the surface of the nonmagnetic substrate 100, the nonmagnetic substrate 100 is cleaned.

In the cleaning step, the nonmagnetic substrate 100 is sprayed with water containing a cleaning material by a spray machine 113, thereby shavings adhered to the surface of the nonmagnetic substrate 100 are roughly washed away (step S2 of FIG. 3).

Then, a tape 114B wound around the rubber roller 114A is pressed against the nonmagnetic substrate 100, a tape device 112 of FIG. 4 is disposed at the end-face of the nonmagnetic substrate 100, and the nonmagnetic substrate 100 is rotated (step S3 of FIG. 3). As a result, the tape 114B wipes out the shavings and cleaning material or the like adhered to the surface of the nonmagnetic substrate 100, and the tape device 112 wipes out the shavings and cleaning material or the like adhered to the end-face of the nonmagnetic substrate 100.

It is preferable to employ an application mode of the disk manufacturing method in which the cleaning step further includes a tape cleaning step that sprays a liquid on the surface of the disk after the processing step and roughly cleans the residue on the surface of the disk by bringing a tape into contact with the surface of the disk while rotating the disk, and the end-face cleaning step is performed concurrently with the tape cleaning step.

The end-face cleaning step is performed while the nonmagnetic substrate 100 is sprayed with the liquid, so that the residue adhered to the end-face of the disk can be efficiently removed. The process in step S3 in which the end-face of the nonmagnetic substrate 100 is cleaned and the tape 114B wipes out the surface of the nonmagnetic substrate 100 corresponds to an example of the end-face cleaning step in the basic mode of the disk manufacturing method and an example of the tape cleaning step in the application mode of the disk manufacturing method as well.

When the cleaning by the tape 114B is finished, the nonmagnetic substrate 100 is dipped in a water tank 115 filled with the water containing the cleaning material, and ultrasonic cleaning is performed to the nonmagnetic substrate 100 (step S4 of FIG. 3). At this point, the surface of the nonmagnetic substrate 100 is etched to float the residue entering into the pit on the surface of the nonmagnetic substrate 100. A scrubbing material 117 is pressed against the surface of the nonmagnetic substrate 100, the nonmagnetic substrate 100 is sprayed with water from a spray machine 116, and the nonmagnetic substrate 100 is rotated, thereby the floating residue is scrubbed by the scrubbing material 117 (step S5 of FIG. 3). The nonmagnetic substrate 100 is sprayed with water having an ultrasonic oscillation from a spray machine 118, thereby the shavings of the scrubbing material 117 are washed out (step S6 of FIG. 3). A soft sponge can be used as the scrubbing material 117. The combined process of steps S2, S3, S4, S5, and S6 corresponds to an example of the cleaning step in the basic mode of the disk manufacturing method.

As illustrated in step S1 of FIG. 3, when the surface of the nonmagnetic substrate 100 is polished while the polishing material 111B is pressed against the rotating nonmagnetic substrate 100, the surface roughness of the end-face of the nonmagnetic substrate 100 tends to be larger than that of the surface, and the residue on the end-face of the nonmagnetic substrate 100 may possibly adhere to the surface of the nonmagnetic substrate 100 in the manufacturing process. In the first embodiment, the end-face of the nonmagnetic substrate 100 is cleaned by the tape device 112 concurrently with the surface processing step (step S1 of FIG. 3) and tape cleaning step (step S3 of FIG. 3) in which the nonmagnetic substrate 100 is rotated, so that the residue adhered to the nonmagnetic substrate 100 can be certainly removed without increasing the processing time.

After cleaning the nonmagnetic substrate 100, the nonmagnetic substrate 100 is rotated at high speed to dry (step S7 of FIG. 3). Step S7 corresponds to an example of the drying step in the basic mode of the disk manufacturing method.

When the surface processing, cleaning, and drying of the nonmagnetic substrate 100 are finished, a magnetic layer is laminated on the surface of the nonmagnetic substrate 100 to produce a magnetic disk. In the first embodiment, the residues adhered to the surface and end-face of the nonmagnetic substrate 100 are securely removed, which can reduce a problem of laminating the recording layer on the residue and prevent troubles in which the head collides with the projection or the electromagnetic induction of the head is adversely affected to erase the recorded data due to a projection or flaw generated on the surface of the magnetic disk.

Now that the explanation of the first embodiment of the disk manufacturing method is finished, a second embodiment will be described next. The second embodiment has almost the same formation as the first embodiment but differs only in the cleaning device that cleans the end-face of the disk. Therefore, the same component as the first embodiment is designated by the same numeral to omit the description, and only the differences are described.

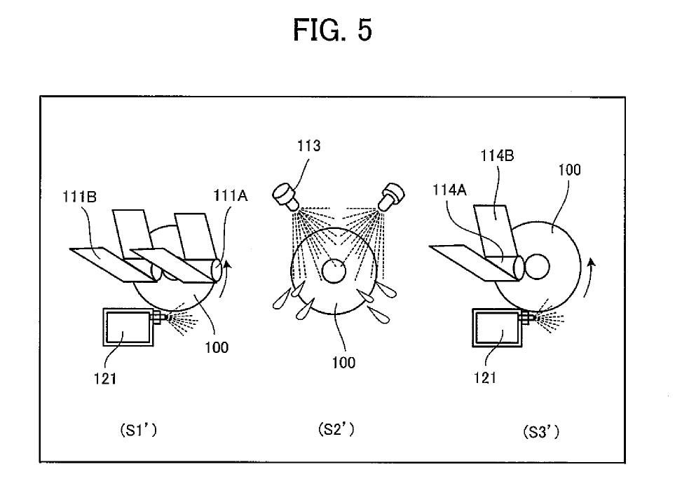

FIG. 5 partially illustrates a method for manufacturing a magnetic disk according to the second embodiment as the basic mode of the disk manufacturing method.

In the magnetic disk manufacturing method of the second embodiment, similarly to the process in step S1 of FIG. 3, the nonmagnetic substrate 100 is rotated while the polishing material 111B wound around the rubber roller 111A is pressed against the nonmagnetic substrate 100, thereby polishing the surface of the nonmagnetic substrate 100 (step S1′ of FIG. 5). Similarly to the process in step S2 of FIG. 3, the nonmagnetic substrate 100 is sprayed with the water containing the cleaning material from the spray machine 113, thereby roughly washing out the shavings generated on the surface processing step (step S2′ of FIG. 5). Similarly to the process in step S3 of FIG. 3, the nonmagnetic substrate 100 is rotated while the tape 114B wound around the rubber roller 114A is pressed against the nonmagnetic substrate 100, thereby wiping out the residue adhering to the surface of the nonmagnetic substrate 100 (step S3′ of FIG. 5). In the second embodiment, the end-face of the nonmagnetic substrate 100 is sprayed with water from a spray machine 121, and the nonmagnetic substrate 100 is rotated, thereby washing out the residue adhering to the end-face of the nonmagnetic substrate 100.

It is preferable to employ an application mode of the disk manufacturing method in which the end-face cleaning washes out the residue on the end-face of the disk by spraying a liquid on the end-face of the disk.

Since the end-face of the disk is sprayed with the liquid while the disk is rotated, the residue adhering to the end-face of the disk can be easily removed.

The processes in steps S1′ and S3′ of FIG. 5 in which the end-face of the nonmagnetic substrate 100 is sprayed with the liquid correspond to an example of the end-face cleaning step in the basic mode of the disk manufacturing method.

Thus, the residue adhering to the disk can easily be removed without scratching the disk by spraying the end-face of the disk with the liquid.

Next, a third embodiment of the magnetic disk manufacturing method will be described below. The third embodiment differs from the first embodiment in the cleaning step of cleaning the end-face of the disk. Therefore, the same component as the first embodiment is designated by the same numeral to omit the description, and only the differences from the first and second embodiments are described.

In the magnetic disk manufacturing method of the third embodiment, unlike the first embodiment in FIG. 3, after the ultrasonic cleaning of the nonmagnetic substrate 100 is performed in the water tank 115 (step S4 of FIG. 3), the end-face of the nonmagnetic substrate 100 is cleaned by the scrubbing cleaning (step S5 of FIG. 3) and the ultrasonic cleaning with the spraying (step S6 of FIG. 3).

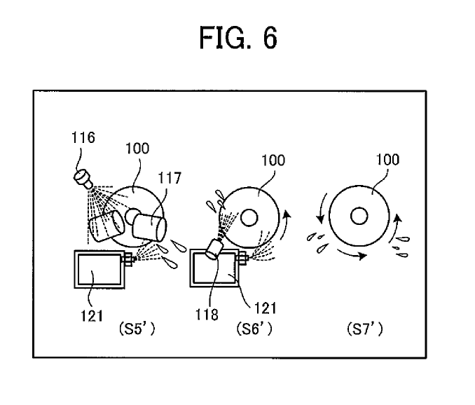

FIG. 6 partially illustrates a method for manufacturing a magnetic disk according to the third embodiment as the basic mode of the disk manufacturing method.

FIG. 6 illustrates steps after step S5 in FIG. 3.

In the magnetic disk manufacturing method of the third embodiment, when the nonmagnetic substrate 100 is put into the water tank 115 to perform the ultrasonic cleaning, the scrubbing material 117 is pressed against the surface of the nonmagnetic substrate 100, the surface of the nonmagnetic substrate 100 is sprayed with the water from the spray machine 116, the nonmagnetic substrate 100 is rotated, and the end-face of the nonmagnetic substrate 100 is sprayed from the spray machine 121 (step S5′ of FIG. 6). As a result, the residue floated on the surface of the nonmagnetic substrate 100 is scrubbed by the scrubbing material 117, and the residue adhering to the end-face of the nonmagnetic substrate 100 is also washed out by the water sprayed from the spray machine 121.

It is preferable to employ an application mode of the disk manufacturing method in which the cleaning step further includes a scrubbing step that sprays a liquid on the surface of the disk and scrubs the surface of the disk by bringing a scrubbing material into contact with the surface of the disk while rotating the disk, and the end-face cleaning step is performed concurrently with the scrubbing step.

The sponge scrap generated in the scrubbing step can securely be removed in addition to the residue generated in the polishing step by simultaneously performing the end-face cleaning step and the scrubbing step. The scrubbing material 117 corresponds to an example of the scrubbing material in the application mode of the disk manufacturing method. The process in step S5′ in which the residue on the end-face of the nonmagnetic substrate 100 is washed out while the end-face of the nonmagnetic substrate 100 is scrubbed by the scrubbing material 117 corresponds to an example of the scrubbing step and an example of the end-face cleaning step as well in the application mode of the disk manufacturing method.

When the residue adhering to the nonmagnetic substrate 100 is scrubbed by the scrubbing material 117, the end-face of the nonmagnetic substrate 100 is sprayed with the water from the spray machine 121 while the surface of the nonmagnetic substrate 100 is sprayed with the water having the ultrasonic oscillation from the spray machine 118, and the nonmagnetic substrate 100 is rotated (step S6′ of FIG. 6).

It is preferable to employ an application mode of the disk manufacturing method in which the cleaning step further includes a high-frequency cleaning step that sprays the surface of the disk with a liquid imparted with a high-frequency oscillation and washes out the residue on the surface of the disk while rotating the disk, and the end-face cleaning step is performed concurrently with the high-frequency cleaning step.

Since the residue adhering to the surface of the disk is floated and washed out by spraying the surface of the disk with the liquid having the high-frequency oscillation, thus the flowing residue can easily adhere to the end-face. By performing the high-frequency cleaning step and the end-face cleaning step at the same time, the residue flowing into the end-face can securely be washed out.

The process in step S6′ in which the end-face of the nonmagnetic substrate 100 is cleaned while the surface of the nonmagnetic substrate 100 is sprayed with the water having the ultrasonic oscillation corresponds to an example of the high-frequency cleaning step and an example of the end-face cleaning step as well in the application mode of the disk manufacturing method.

Thus, even if the residue generated by the scrubbing step or the high-frequency cleaning step adheres to the end-face of the disk, the residue on the end-face of the disk is securely cleaned by performing the end-face cleaning step concurrently with the scrubbing step and the high-frequency cleaning step, so that the problem of laminating the recording layer on the residue can be reduced.

In the above embodiments, an example of employing a magnetic disk that records information with the use of the magnetic field is explained. However, for example, a MO disk or the like may be used as a disk in the disk manufacturing method.

### EXAMPLES

Examples of the present invention will be described below.

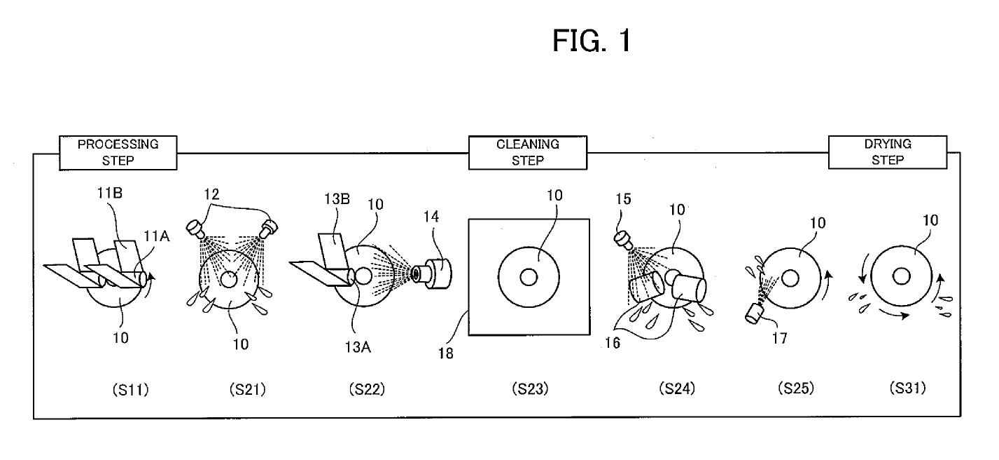

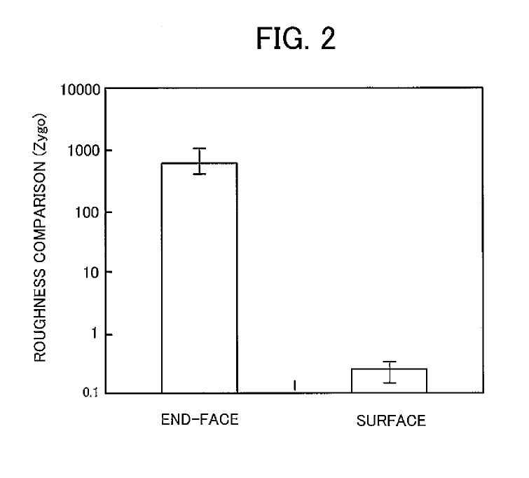

As a conventional example, a magnetic disk is manufactured according to the magnetic disk manufacturing method illustrated in FIG. 1. After the surface processing that includes the polishing step (step S11 of FIG. 1), the shower cleaning step (step S21 of FIG. 1), the tape cleaning step (step S22 of FIG. 1), the ultrasonic cleaning step (step S23 of FIG. 1), the scrubbing cleaning step (step S24 of FIG. 1), the ultrasonic cleaning step with the spraying (step S25 of FIG. 1), and the drying step (step S31 of FIG. 1) is performed to the nonmagnetic substrate 10, a recording layer is laminated on the nonmagnetic substrate 10 to produce a magnetic disk.

As a first example of the present invention, a magnetic disk is manufactured according to the magnetic disk manufacturing method illustrated in FIG. 3, and the end-face cleaning by the tape device 112 is simultaneously performed at the polishing step (step S11 of FIG. 1) and the tape cleaning step (step S22 of FIG. 1) of the magnetic disk manufacturing method illustrated in FIG. 1.

As a second example of the present invention, a magnetic disk is manufactured according to the magnetic disk manufacturing method illustrated in FIG. 5, and the end-face cleaning by the spray machine 121 is simultaneously performed at the polishing step (step S11 of FIG. 1) and the tape cleaning step (step S22 of FIG. 1) of the magnetic disk manufacturing method illustrated in FIG. 1.

The number of residues adhering to the surface of the nonmagnetic substrate before the lamination, the surface roughness, and the number of scratches (flaws) generated on the surface of the produced magnetic disk are measured when the magnetic disk is produced.

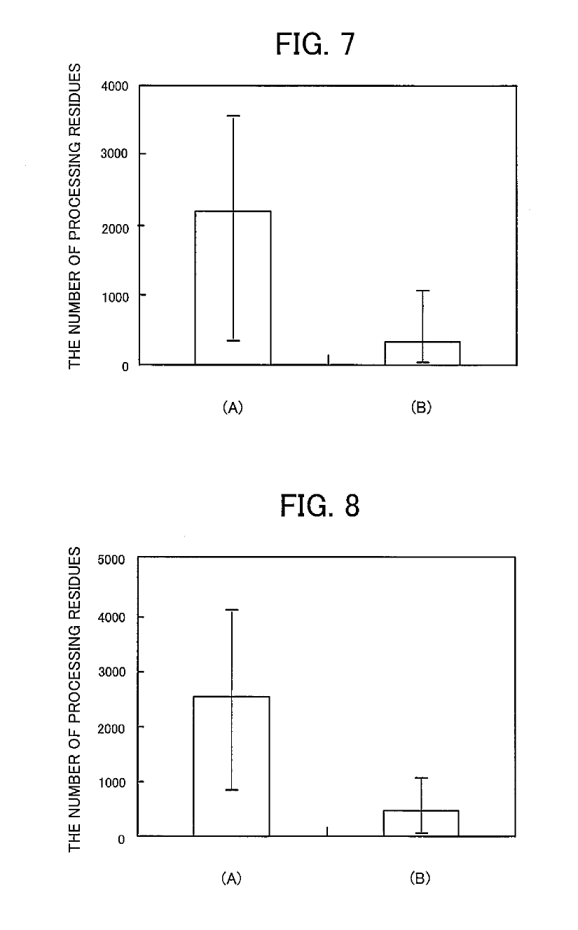

FIG. 7 illustrates a comparison between the conventional example and the first example, about the number of residues adhering to the surface of the nonmagnetic substrate after the polishing step; and FIG. 8 illustrates a comparison between the conventional example and the second example, about the number of residues adhering to the surface of the nonmagnetic substrate after the polishing step.

Part (A) of FIGS. 7 and 8 illustrates the number of residues adhering to the surface of the nonmagnetic substrate after the polishing step (step S11 of FIG. 1) in the conventional example. However, they are measurement results of different specimens. Part (B) of FIG. 7 illustrates the number of residues adhering to the surface of the nonmagnetic substrate after the polishing step (step S1 of FIG. 3) in the first example, and part (B) of FIG. 8 illustrates the number of residues adhering to the surface of the nonmagnetic substrate after the polishing step (step S1′ of FIG. 5) in the second example.

As illustrated in part (A) of FIGS. 7 and 8, if the end-face cleaning is not performed, the number of residues adhering to the nonmagnetic substrate after the polishing step ranges from about 1000 to 4000 (pieces/one surface). On the other hand, as illustrated in part (B) of FIGS. 7 and 8, if the end-face cleaning is performed, the number of residues can be largely decreased to the range of about 10 to 1000 (pieces/one surface).

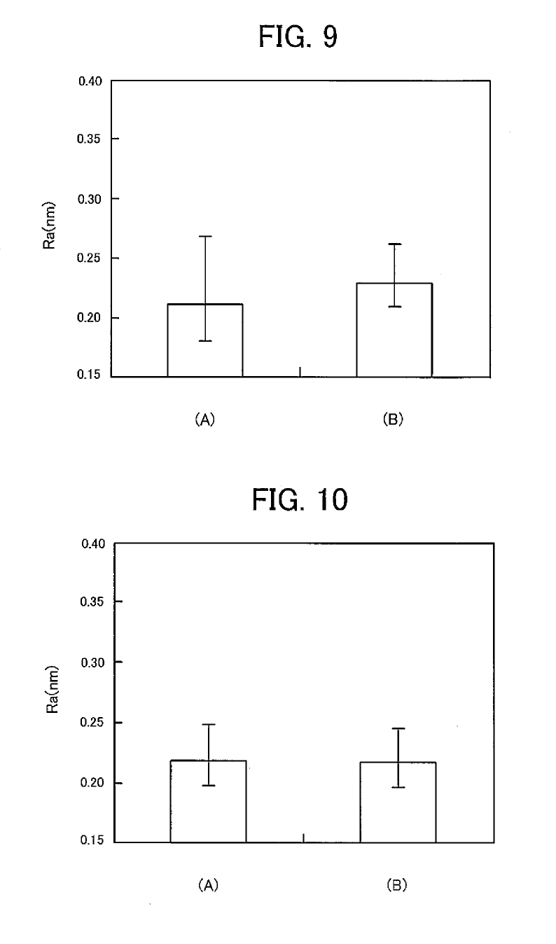

FIG. 9 illustrates a comparison of the surface roughness of the nonmagnetic substrate after the polishing step between the conventional example and the first example, and FIG. 10 illustrates a comparison of the surface roughness of the nonmagnetic substrate after the polishing step between the conventional example and the second example.

Part (A) of FIGS. 9 and 10 illustrates the surface roughness of the nonmagnetic substrate after the polishing step in the conventional example. However, they are measurement results of different specimens. Part (B) of FIG. 9 illustrates the surface roughness of the nonmagnetic substrate after the polishing step in the conventional example, and part (B) of FIG. 10 illustrates the surface roughness of the nonmagnetic substrate after the polishing step in the second example.

As illustrated in part (B) of FIG. 9, if the end-face of the nonmagnetic substrate is cleaned with the use of the tape, as compared with the case in which the end-face of the nonmagnetic substrate is not cleaned, the value of the surface roughness is stable each time although an average surface roughness (Ra) of the nonmagnetic substrate after the polishing step is increased.

As can be found from part (B) of FIG. 10, the end-face cleaning with the water spray achieves the same degree of the surface roughness as the case in which the end-face of the nonmagnetic substrate is not cleaned, and thus influence on the polishing is suppressed.

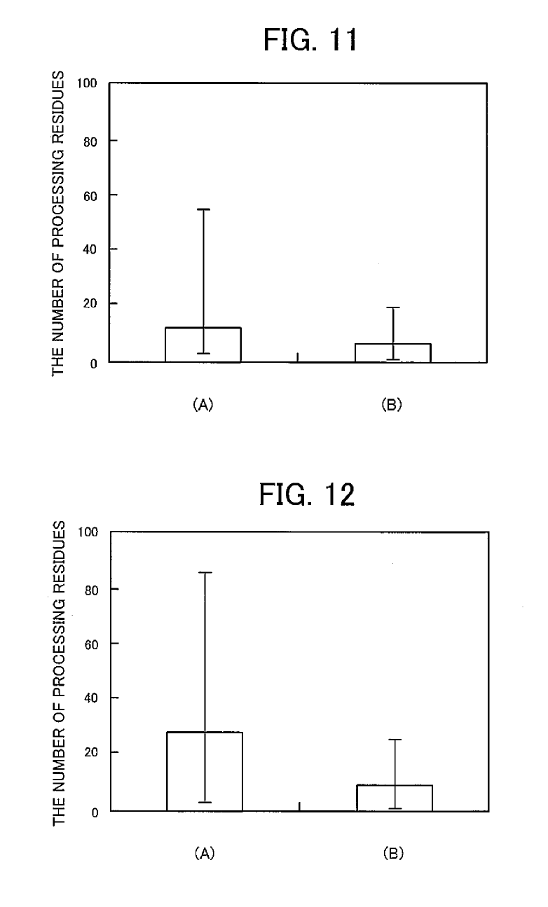

FIG. 11 illustrates a comparison of the number of residues adhering to the nonmagnetic substrate before the lamination between the conventional example and the first example, and FIG. 12 illustrates a comparison of the number of residues adhering to the nonmagnetic substrate before the lamination between the conventional example and the second example.

Part (A) of FIGS. 11 and 12 illustrate the number of residues adhering to the surface of the nonmagnetic substrate after the conventional drying step (step S31 of FIG. 1). However, they are measurement results of different specimens. Part (B) of FIG. 11 illustrates the number of residues adhering to the surface of the nonmagnetic substrate after the drying step (step S7 of FIG. 3) in the first example, and part (B) of FIG. 12 illustrates the number of residues adhering to the surface of the nonmagnetic substrate after the polishing step (performing the process in step S3′ of FIG. 5 followed by the processes in steps S4 to S7 of FIG. 3) in the second example.

As illustrated in part (A) of FIGS. 11 and 12, even if the end-face cleaning is not performed, the number of residues adhering to the surface of the nonmagnetic substrate after the polishing step is decreased compared with the measurement result of part (A) of FIG. 7. However, the number of residues of part (A) of FIGS. 11 and 12 distributes widely compared with the case in which the end-face cleaning is performed. Thus, it is found that the number of residues adhering to the surface of the nonmagnetic substrate can be stably decreased by cleaning the end-face of the nonmagnetic substrate.

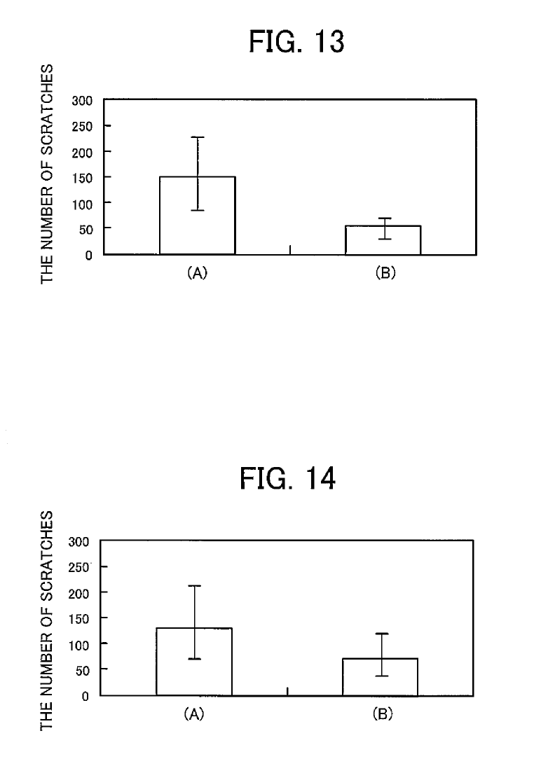

FIG. 13 illustrates a comparison of the number of scratches generated on the magnetic disk surface between the conventional example and the first example, and FIG. 14 illustrates a comparison of the number of scratches generated on the magnetic disk surface between the conventional example and the second example.

Part (A) of FIGS. 13 and 14 illustrate the number of scratches generated on the magnetic disk surface of the conventional example generated through the manufacturing process in FIG. 1. However, they are measurement results of different specimens. Part (B) of FIG. 13 illustrates the number of scratches generated on the magnetic disk surface of the first example generated through the manufacturing process in FIG. 3, and part (B) of FIG. 14 illustrates the number of scratches generated on the magnetic disk surface of the second example generated through the manufacturing process in FIG. 5.

As illustrated in FIGS. 12 and 13, it is found that the number of scratches generated on the finally produced magnetic disk can decreased by cleaning the end-face of the nonmagnetic substrate. It can be considered that the residue causing the scratch is securely removed from the surface of the nonmagnetic substrate.

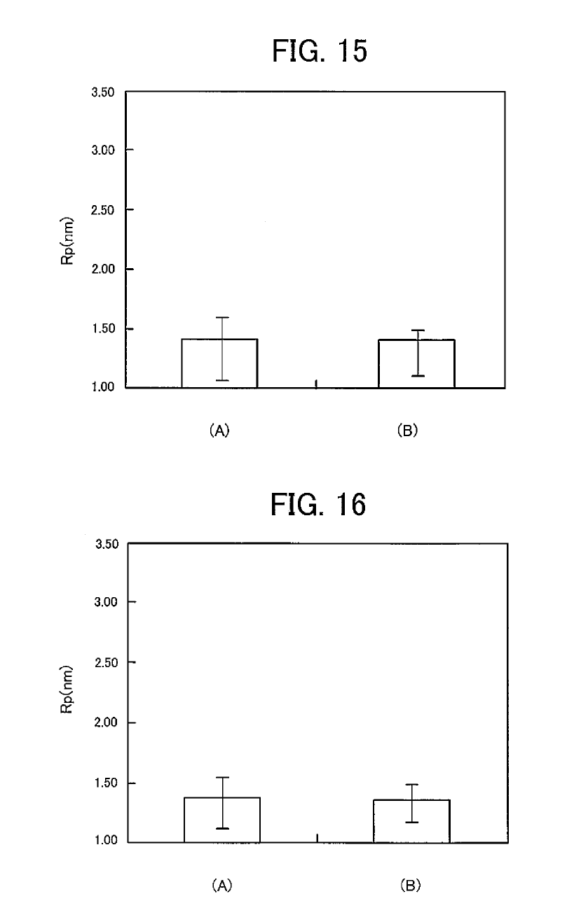

FIG. 15 illustrates a comparison of the average linear height (Rp) of the magnetic disk between the conventional example and the first example, and FIG. 16 illustrates a comparison of the average linear height of the magnetic disk between the conventional example and the second example. Here, the average linear height indicates a maximum height component from an average line defined by the average surface roughness.

Part (A) of FIGS. 15 and 16 illustrate the average linear height of the magnetic disk of the conventional example generated through the manufacturing process in FIG. 1. However, they are measurement results of different specimens. Part (B) of FIG. 15 illustrates the average linear height of the magnetic disk of the first example generated through the manufacturing process in FIG. 3, and FIG. 16 illustrates the average linear height of the magnetic disk of the second example generated through the manufacturing process in FIG. 5.

As the average linear height of the finally produced magnetic disk in FIGS. 15 and 16 depicts, same degree of evenness can be maintained when the end-face of the nonmagnetic substrate is cleaned, in comparison with the case in which the end-face of the nonmagnetic substrate is not cleaned.

Thus, according to the first and second examples, it is possible to maintain the evenness of the surface roughness of the finally produced magnetic disk and to certainly decrease the number of scratches generated on the magnetic disk.

According to the basic mode of the disk manufacturing method, the end-face of the disk is cleaned while rotating the disk at the same time with at least one of the processing step and the cleaning step. Therefore, it is possible to prevent the residue from entering into the minute pit on the end-face and adhering to the surface of the disk during the manufacturing process. Otherwise, the residue may generate a projection or a flaw on the surface of the disk and make the head collide with the projection or bring about adverse effects on the electromagnetic induction of the head, such as erasure of recorded data.

As described above, according to this basic mode of the disk manufacturing method, the problem of laminating the recording layer on the disk while the residue adheres to the surface of the disk can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A method for manufacturing a disk, comprising:
processing a surface of a disk while rotating the disk;
cleaning the surface of the disk after the processing to remove a processing residue from the disk;
drying the disk after the cleaning; and
end-face cleaning that cleans an end-face of the disk while rotating the disk, the end-face cleaning being performed concurrently with at least one of the processing and the cleaning.

2. The method for manufacturing a disk according to claim 1, wherein the end-face cleaning wipes out the residue from the end-face of the disk by bringing a tape into contact with the end-face of the disk.

3. The method for manufacturing a disk according to claim 1, wherein the end-face cleaning washes out the residue on the end-face of the disk by spraying a liquid on the end-face of the disk.

4. The method for manufacturing a disk according to claim 2, wherein the end-face cleaning washes out the residue on the end-face of the disk by spraying a liquid on the end-face of the disk.

5. The method for manufacturing a disk according to claim 1, wherein the processing further comprises polishing that polishes the surface of the disk by bringing a polishing material into contact with the surface of the disk while rotating the disk, and
the end-face cleaning is performed concurrently with the polishing.

6. The method for manufacturing a disk according to claim 2, wherein the processing further comprises polishing that polishes the surface of the disk by bringing a polishing material into contact with the surface of the disk while rotating the disk, and
the end-face cleaning is performed concurrently with the polishing.

7. The method for manufacturing a disk according to claim 3, wherein the processing further comprises polishing that polishes the surface of the disk by bringing a polishing material into contact with the surface of the disk while rotating the disk, and
the end-face cleaning is performed concurrently with the polishing.

8. The method for manufacturing a disk according to claim 1, wherein the cleaning further comprises a tape cleaning that sprays a liquid on the surface of the disk after the processing and roughly cleans the residue on the surface of the disk by bringing a tape into contact with the surface of the disk while rotating the disk, and
the end-face cleaning is performed concurrently with the tape cleaning.

9. The method for manufacturing a disk according to claim 2, wherein the cleaning further comprises a tape cleaning that sprays a liquid on the surface of the disk after the processing and roughly cleans the residue on the surface of the disk by bringing a tape into contact with the surface of the disk while rotating the disk, and
the end-face cleaning is performed concurrently with the tape cleaning.

10. The method for manufacturing a disk according to claim 3, wherein the cleaning further comprises a tape cleaning that sprays a liquid on the surface of the disk after the processing and roughly cleans the residue on the surface of the disk by bringing a tape into contact with the surface of the disk while rotating the disk, and
the end-face cleaning is performed concurrently with the tape cleaning.

11. The method for manufacturing a disk according to claim 1, wherein the cleaning further comprises scrubbing that sprays a liquid on the surface of the disk and scrubs the surface of the disk by bringing a scrubbing material into contact with the surface of the disk while rotating the disk, and
the end-face cleaning is performed concurrently with the scrubbing.

12. The method for manufacturing a disk according to claim 2, wherein the cleaning further comprises scrubbing that sprays a liquid on the surface of the disk and scrubs the surface of the disk by bringing a scrubbing material into contact with the surface of the disk while rotating the disk, and
the end-face cleaning is performed concurrently with the scrubbing.

13. The method for manufacturing a disk according to claim 3, wherein the cleaning further comprises scrubbing that sprays a liquid on the surface of the disk and scrubs the surface of the disk by bringing a scrubbing material into contact with the surface of the disk while rotating the disk, and
the end-face cleaning is performed concurrently with the scrubbing.

14. The method for manufacturing a disk according to claim 1, wherein the cleaning further comprises high-frequency cleaning that sprays the surface of the disk with a liquid imparted with a high-frequency oscillation and washes out the residue on the surface of the disk while rotating the disk, and
the end-face cleaning is performed concurrently with the high-frequency cleaning.

15. The method for manufacturing a disk according to claim 2, wherein the cleaning further comprises high-frequency cleaning that sprays the surface of the disk with a liquid imparted with a high-frequency oscillation and washes out the residue on the surface of the disk while rotating the disk, and
the end-face cleaning is performed concurrently with the high-frequency cleaning.

16. The method for manufacturing a disk according to claim 3, wherein the cleaning further comprises high-frequency cleaning that sprays the surface of the disk with a liquid imparted with a high-frequency oscillation and washes out the residue on the surface of the disk while rotating the disk, and
the end-face cleaning is performed concurrently with the high-frequency cleaning.
